(19) United States
(12) Patent Application Publication
(10) Pub. No.: US 2024/0273977 A1
(43) Pub. Date: Aug. 15, 2024

(54) METHOD AND SYSTEM FOR CREATING LOTTERTY STYLE EVENTS FROM SPORTING EVENT OUTCOMES

(71) Applicant: Todd Fishon, Henderson, NV (US)

(72) Inventor: Todd Fishon, Henderson, NV (US)

(21) Appl. No.: 18/109,141

(22) Filed: Feb. 13, 2023

(51) Int. Cl. G07F 17/32; G06Q 50/34

(52) U.S. Cl. CPC G07F 17/329; G06Q 50/34; G07F 17/3209; G07F 17/3211; G07F 17/3225; G07F 17/3288

(57) ABSTRACT

A system and method for presenting a lottery type game based upon at least one sporting event, comprises a user device, a database and a game server. The game server is configured to, relative to a plurality of contests relating to the at least one sporting event to cause the user device to display first and second sets of icons corresponding to opponents of the event, receive input from a player of a selection of one of the icons from each set, assign numerical values to the selected icons, and repeat for each of the plurality of contests. The assigned numerical values are stored in the database and the outcome of the game is determined by comparing a score which corresponds to each contest of the at least one sporting event to the stored assigned numerical values for the corresponding contest to determine one or more matches thereof.

### FIELD OF THE INVENTION

The present invention relates to methods and systems for awarding game players with prizes.

### BACKGROUND OF THE INVENTION

Using the score of a sporting event has been used for entertainment for big events like the NFL Super Bowl®, such as known “Super Bowl Box” pools. In these pools, a 10×10 grid of 100 boxes is created. Participants buy one or more boxes of the pool (for example, 100 participants might each place a $10 wager to buy one box). Numbers from 0 to 9 are randomly selected and assigned to each column and numbers from 0 to 9 are randomly selected and assigned to each row (where the numbers 0-9 are each used only once in the columns and in the rows). Each box of the grid can be correlated to a two digit number comprising the number assigned to the row that the box sits in and the number assigned to the column that the box sits in.

An outcome of a sports event may then be used to determine the winner of the pool. For example, the sports event may be a football game between teams A and B, where a score of the game, such as the final score, is utilized. In one configuration, the winner of the pool is determined by the last digit of each team's score. As an example, the final score between teams A and B may be 27-23 in favor of Team A. In that event, the outcome is represented by the numbers 7 and 3. The winner of the pool would then be the participant who selected the box which corresponds to Team A-7 and Team B-3. For example, if the rows of the grid correspond to Team A and the third row was assigned the number 7 and if the columns of the grid correspond to Team B and the fifth column was assigned the number 3, then the winner would be the participant who selected the box located at row 3, column 5. That participant might be paid an award, such as all or a portion of the pool.

This method provides several options for determining a winner as a 1 in 100 chance to have the number combination representing the final score. Another option is to let different times of a sporting event such as the score at the end of each quarter in a football game be used to designate a winning combination.

A variation of this game is described in U.S. Publication No. 2016/0210815. This application describes a single player implementation—e.g. a “non-pool” variation of the game where an individual player may select the event which he or she wishes to wager upon, and selects one or more boxes of a 10×10 grid. Numbers from 0-9 are randomly assigned to the rows and columns in a similar manner to standard box pools as described above, and a determination is made whether the player has won their wager with reference to the selected box (and associated assigned row and column numbers) to the event outcome. In this variation of the game, instead of multiple players selecting boxes from a single grid, a single player selects one or more boxes from a grid. In this variation, players play different box games (such as having different numbers assigned to the rows and columns) and each player may select the same box on the grid (whereas in standard box pools, players each choose one or more different boxes from the grid until no empty boxes remain).

A number of problems exist with these existing box type pools or games. In particular, traditional pool-style box games are generally offered or run by individuals or groups of individuals for fun. Thus, only persons who are invited to join the play the pool are familiar with the game. While the box game described in U.S. Publication No. 2016/0210815 aids in addressing this problem because it represents a game which can be marketed to individual players, other problems exist. For example, another problem with existing box games is the limited number of outcomes (100), which limits the potential size of awards which may be awarded (due to limitations in the odds of winning (1 in 100)).

An improved system and method for awarding secondary prizes to players which overcomes these and other problems, is desired.

### SUMMARY OF THE INVENTION

Aspects of the invention comprise methods and systems for creating and presenting a lottery-type event which is based upon one or more external events, and preferably one or more sporting events (or games/contests).

One embodiment of the invention is a system for presenting a lottery type game based upon at least one sporting event, comprising a user device which comprises a controller, a display, at least one user input, and a communication interface; a database; and a game server comprising a processor, a memory, a communication interface, and machine-readable code stored in said memory and executable by said processor. The machine-readable code is configured to cause the game server to, relative to a plurality of contests relating to the at least one sporting event: (a) cause the display of the user device to display a first set of icons corresponding to a first opponent and a second set of icons corresponding to a second opponent; (b) receive, from the user device, input regarding a selection of one of the icons from the first set of icons and one of the icons from the second set of icons; (c) assign numerical values to the selected icons; (d) cause the display of the user device to graphically transform the selected icons to the assigned numerical values; and (e) repeat steps (a)-(d) for each of the plurality of contests, and to store, in the database, information regarding the numerical values assigned to the plurality of contests and determine the outcome of the lottery type game by comparing a score which corresponds to each contest of the at least one sporting event to the stored assigned numerical values for the corresponding contest to determine one or more matches thereof.

The contests may comprise portions of the same event between the same opponents, such as quarters of a basketball game, or contests between different opponents, such as different soccer games.

The outcome of the game may be determined by comparing the assigned game numbers for each contest to the scores of the actual sporting event(s) which correspond to the contests. In one configuration, the assigned game numbers are single digit numbers, such as 0-9, and the assigned game numbers are compared to the final digit of the scores of the corresponding opponents of the sporting event(s).

Further objects, features, and advantages of the present invention over the prior art will become apparent from the detailed description of the drawings which follows, when considered with the attached figures.

### DESCRIPTION OF THE DRAWINGS

FIG. 1 illustrates a system in accordance with an embodiment of the invention; and

FIG. 2 is a flow diagram illustrating one example of a method of the invention;

FIGS. 3A-3E illustrate graphical user interfaces which may be generated and displayed in a first example of the invention;

FIGS. 4A-4E illustrate graphical user interfaces which may be generated and displayed in a second example of the invention; and

FIGS. 5A-5D illustrate graphical user interfaces which my be generated and displayed in a third example of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a method and system for creating and presenting a lottery-type event which is based upon one or more external events. Preferably, the external events comprise one or more sporting events (or games/contests).

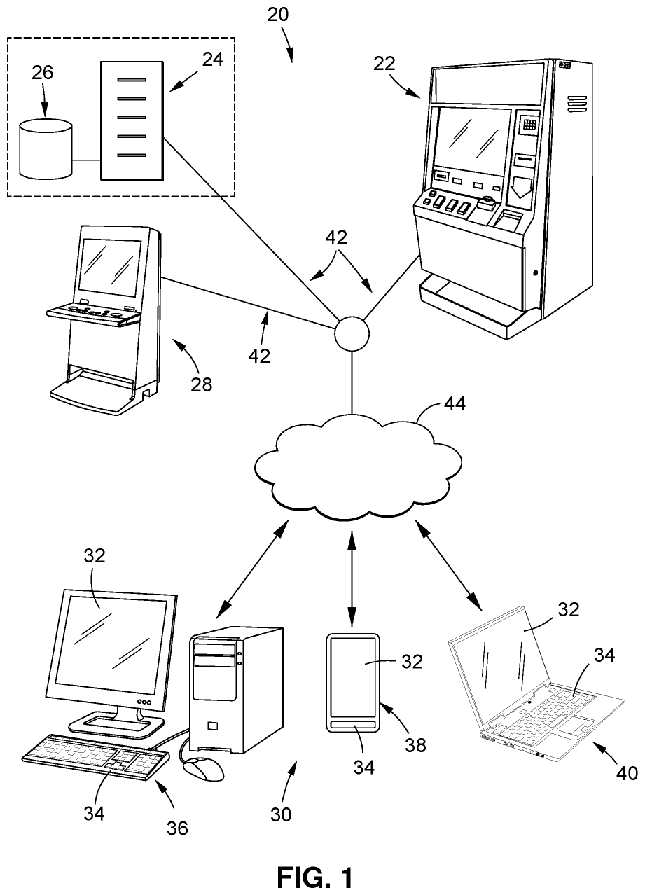

One embodiment of a system 20 of the invention will be described with reference to FIG. 1. The system 20 might be associated with (such as by being operated by, or being partially located at), a casino. As illustrated, the system 20 may include one or more gaming machines or devices 22. The gaming machine 22 may have a variety of configurations, but may comprise a housing or cabinet for supporting and/or enclosing various components required for operation of the gaming machine. In the embodiment, the housing may include at least one door or panel located at a front thereof, the door capable of being moved between an open position which allows access to the interior, and a closed position in which access to the interior is generally prevented. The gaming machine may have an “upright” configuration, but could have other configurations, shapes or dimensions (such as being of a “slant”-type, “bar-top” or other configuration as is well known to those of skill in the art).

The gaming machine 22 preferably includes at least one first display device configured to display game information. The display device may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display device may be capable of projecting or displaying a wide variety of information, including images, symbols and other indicia or information associated with game play, game promotion or other events. The gaming machine might include more than one display device, such as a main or first display device and a secondary display device. The two or more display devices might be associated with the housing or the gaming machine might also include a top box or other portion which includes the one or more second display devices. Also, the gaming machine might include side displays (such as mounted to the exterior of the housing) and might include multiple displays of differing sizes.

The gaming machine 22 is preferably configured to present one or more games upon a player making a monetary payment or wager. In this regard, as described in more detail below, the gaming machine 22 may include mechanism or means for accepting monetary value.

In one embodiment, as described in detail herein, certain outcomes (but preferably not all outcomes) may be designated as winning outcomes (the non-winning outcomes may be referred to as losing outcomes) and awards may be provided for winning outcomes, such as monetary payments (or representations thereof, such as prize of credits) as detailed herein. As detailed below, the gaming machine 22 may include a mechanism or means for returning unused monetary funds and/or dispensing winnings to a player.

The gaming machine 22 preferably includes one or more player input devices (such as input buttons, plunger mechanisms, a touch-screen display, joystick, touch-pad or the like). These one or more devices may be utilized by the player to facilitate game play, such as by providing input or instruction to the gaming machine 22. For example, such input devices may be utilized by a player to place a wager, cause the gaming machine 22 to initiate a game, to “cash out” of the gaming machine, or to provide various other inputs.

In one preferred embodiment, the gaming machine 22 includes at least one microprocessor or controller for controlling the gaming machine, including receiving player input and sending output signals for controlling the various components or peripheral devices of the machine 22 (such as generating game information for display by the display devices). The controller may be arranged to receive information regarding funds provided by a player to the gaming machine 22, receive input such as a purchase/bet signal when a purchase/bet button is depressed, and receive other inputs from a player. The controller may be arranged to generate information regarding a game, such as game information for display by the at least one display device, for determining winning or losing game outcomes and for displaying information regarding awards for winning game wagers, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information including tracked game play information). The gaming machine 22 may also include one or more random number generators for generating random numbers (such as implemented by a random number generator software module stored in the memory and executable by the processor), such as for use in selecting game elements (as described below) and for presenting a game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions (e.g. software) which are configured to implement the game. In this regard, the gaming machine 22 is specially configured to present a game of the invention via specific software and/or hardware which causes the gaming machine to operate uniquely. For example, the controller of the gaming machine 22 may be configured to detect a wager, such as a signal from a player's depressing of an “game bet” button. Upon such an event and/or the player otherwise signaling the gaming machine 22 to present the game, the controller may be configured to cause the at least one display to display unique information, such as a unique graphical interface or unique game display, including game information. The controller may accept input from a player of game inputs via the one or more player input devices of the gaming machine 22. As indicated above, the machine readable code may be configured in various manners, such as by having various “modules” of software which are designed to implement specific features of the game play or game presentation.

The gaming machine 22 may be configured to generate and present games in a stand-alone manner or it may be in communication with one or more external devices or systems at one or more times—such as one or more game servers 24 as described below. The gaming machine 22 might communicate with one or more of such external devices or systems via one or more communication ports or other interface devices. These ports or interface devices may be configured to implement various communication protocols (including proprietary protocols) and communicate via wireless, wired or other communication link. For example, the gaming machine 22 may be configured as a server-based device and obtain game code or game outcome information from the remote game server (in which event the gaming machine controller may receive game information from the server, such as game outcome information, and use that server-generated information to present the game at the gaming machine).

As indicated, the gaming machine 22 is configured to present one or more wagering games. The gaming machine 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, the gaming machine 22 might include a coin acceptor for accepting coins. Of course, associated coin reading/verifying devices and coin storage devices may be associated with the gaming machine 22 if it is configured to accept coins. Likewise, the gaming machine 22 might include a media reader. Such a reader may be configured to accept and read/verify paper currency and/or other media such as tickets. Of course, in such event the gaming machine 24 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account or wallet, or a bank or other financial institution account. Such a mechanism might include a communication interface which permits the gaming machine to communicate with a mobile phone, PDA, tablet or other electronic device of the player (such as via a physical interface or wired or wireless communications, such as to enable the transfer of funds from the player to the gaming machine or system.

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). Such wager input options may allow the player to wager on the base game and optionally place a side bonus bet in accordance with the present invention. In one embodiment, when the player's wager is received, the player's credit balance is reduced by the number of wagered credits. The player might then provide a separate input to begin the game. In other embodiment, the player might select a “play game” input, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In this regard, the gaming machine 22 may include one or more media printers or writers. In other embodiments, the cash-out mechanism may result in the funds value being transferred to an external device or account, such as a player's casino account (such as associated with a casino server), a wallet, a remote bank or other financial account, or an electronic device such as a player's phone, PDA or tablet.

The gaming machine 22 may also include a player tracking device, such as a card reader and/or an associated keypad or other input device (such as a touch screen display). Such player tracking devices are well known and may permit the game operator to track play of players of the gaming machine. The tracked play may be utilized to offer player bonuses or awards.

The main game controller or processor may communicate with several of the peripheral devices via one or more intermediary controllers. For example, some of the peripheral devices might comprise USB type or enabled devices which are controlled by an intermediary USB controller.

Still referring to FIG. 1, in one embodiment, the system 20 includes a game server 24. The game server 24 may comprise a processor which is configured to execute machine-readable code (e.g. “software”) stored in an associated memory, which software is preferably configured to cause the processor to implement the functionality described herein. In one embodiment, a database 26 may be associated with the game server 24, such as for storing information as described below.

In one embodiment, the game server 24 may include one or more operator interfaces, such as operator terminals (not shown). Such interfaces might comprise, for example, terminals which include at least one display and one or more user input devices such as a keyboard, mouse, touch-screen, etc. The interfaces may communicate with the game server 24, such as to configure the server 24, display information and the like.

In one embodiment, the game server 24 may be part of one or more other servers or systems, or be integrated therewith. Such systems or servers might comprise a casino accounting system, casino player tracking system or the like.

The system 20 may include one or more kiosks 28. The kiosks 28 may have various configurations. In one embodiment, the kiosk 28 comprises a housing, one or more devices for receiving player input and/or displaying or otherwise providing information to a player, and at least one credit dispensing mechanism. The information input/output devices may include, for example, an electronic touch-screen video display. Other input/output devices may include one or more push-buttons, keypads, keyboards and/or other elements. The credit dispensing mechanism may comprise, but it not limited to one or more of: a currency dispenser, a coin dispenser, a ticket or other media dispenser (such as a magnetic card dispenser), or a media writer (such an RFID encoder or the like).

In one embodiment, the kiosk 28 includes at least one processor for executing machine readable code or software, and at least one memory device for storing machine readable code or software for execution by the processor. In one embodiment, the kiosk 28 includes at least one communication interface, such as for establishing a communication link with one or more other devices, such as the game server 24. The kiosk 28 may be located within a casino, such as where a plurality of kiosks 28 are located about the casino floor for access by players.

As illustrated in FIG. 1, in one embodiment, the system 20 comprises one or more personal devices 30. The personal device 30 may be a dedicated/special purpose device or may be a general purpose device. The personal device 30 is preferably an electronic device, and more preferably a computing device. The personal device 30 may include at least one video display 32 capable of displaying game information, at least one player input device 34, and at least one communication interface.

The personal device 30 might comprise, for example, a desktop computer 36, a telephone (including cellular, wireless or wired telephones) or PDA 38 (such as an iPhone®), a laptop or notebook computer 40, or various other devices. As indicated, the personal device 30 might also comprise a special purpose device such as a specially configured gaming tablet.

The player input device 34 might comprise, for example, a keyboard, mouse, joystick, touch-screen, button(s), track-balls or other devices now known or later configured and which are capable of receiving input from a player. The communication interface is preferably configured to permit information or data to be exchanged from one or more remote device or locations with the personal device 30. The one or more communication interface might support wired or wireless communications using various protocols. For example, if the personal device 30 is a PDA, the communications might be by 3G, 4G, IMT, GSM or the like. If the personal device 30 is a desktop computer, the communications might be by TCP/IP or the like. Of course, other protocols may be used such as Bluetooth, 802.11xx and the like.

It will be appreciated that the personal device 30 may include other components. For example, the personal device 30 may include a main processor, a video and/or audio processor, input and output ports or the like.

In one embodiment, the game server 24 is configured to communicate with one or more user or player devices, which user or player devices may comprise, as detailed herein, the casino gaming machines 22, the kiosks 30, and/or the personal devices 30. In one embodiment, the game server 24 includes at least one communication interface for communicating with the gaming machines 22, kiosks 30 and personal devices 30, such as over one or more wired and/or wireless communication links 42, which links may comprise part of a LAN, WAN or the like. In one embodiment, the links may include or comprise a network, such as the Internet 44.

Additional aspects of the invention will be appreciated from the description below.

In one configuration, the system 20 is configured to implement a wagering event. The wagering event may emulate a lottery-type event by offering at least one outcome having sufficiently low odds of success that it allows for a very high award (such as monetary reward, in relation to the amount wagered). In one embodiment, the outcome of the wagering event is determined, at least in part, by the outcome of one or more sporting events. For example, such sporting events might comprise baseball, soccer, basketball, football or other games or events, or portions thereof (such as quarters or halves), or other events between teams, players or the like, where the outcome of the event is not controlled or controllable by the player.

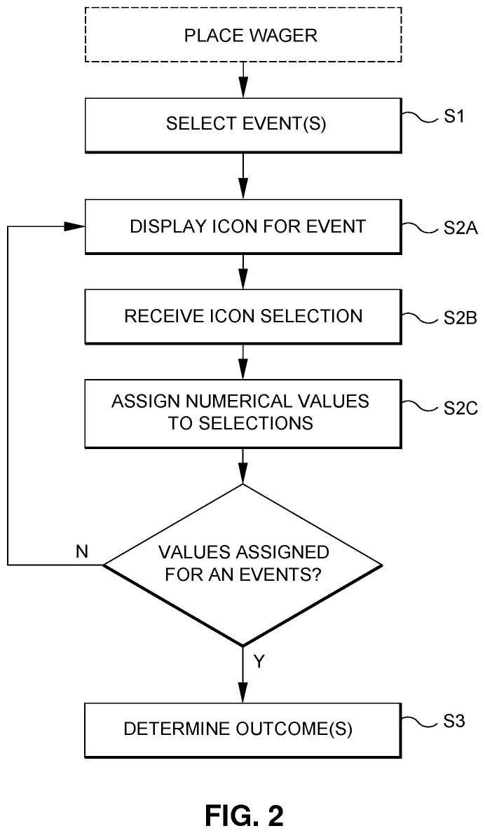

FIG. 2 is a flow diagram illustrating one configuration a method of presenting/playing a game or event of the invention.

As illustrated in FIG. 2, in a step S1, a player may pick or select one or more event(s). As indicated, the one or more events might comprise a basketball game, a football game, or more than one event or game, such as multiple soccer games, etc. In other embodiments, the one or more events might be pre-selected.

Then, for a plurality of contests (quarters of a basketball game, different soccer games, etc.) relating to the event(s):
In a step S2A: display a first set of icons corresponding to a first opponent and a second set of icons corresponding to a second opponent;
In a step S2B: receive a selection of one of the icons from the first set of icons and one of the icons from the second set of icons from the player; and
In a step S2C: assign numerical values to the selected icons;

As illustrated, steps S2A-2C are preferably repeated for each of the plurality of contests of the event(s) (such as 4 or 5 contests between different participants or between the same participants, etc., as further described below).

In a step S3, determine the outcome of each contest by comparing the assigned numerical values to the actual score—where the outcome of the wagering game is based upon the number of contests that the player wins (1, 2, all 4 or 5, etc.), and where the winnings increase for the number of wins.

In one embodiment, the game is played as a wagering game, wherein the player places one or more wagers to play the game.

As described herein in detail, the invention may be implemented by a system 20 such as described above, such as where game information is generated by the server 24 and is then displayed on one of the user devices, such as a kiosk 28, gaming machine 22, or personal device 22, and wherein one or more user inputs may be provided to those devices for use in playing the game. In such a configuration, the game server 24 may cause a display of the user device to display one or more interfaces, such as: 1) a graphical interface which displays information regarding one or more events that the player may select; 2) a graphical interface which displays the sets of icons; 3) a graphical interface which displays the assigned numbers; and 4) a graphical interface which displays a “ticket”, such as in the form of the aggregation of the assigned numbers for the plurality of events.

As described below, the assigned numbers may be randomly selected or assigned, either to the icons before they are displayed or after particular icons are selected. In such a configuration, the player does not control the assigned game numbers.

In a preferred configuration, the assigned game numbers are single digit numbers. For example, the numbers may comprise 0-9 or a subset thereof, such as 0-4. The particular numbers which are used may be selected based upon the particular type of sports events and the most common scores thereof.

This ticket, or information regarding the assigned numbers for that player's game, may be stored in the database associated with the game server 24. The player's game ticket might also be emailed, sent by text message or other manner of communication, to the player, such as to their personal device 30. In this manner, the player may view their game ticket, such as to compare the assigned numbers to the outcomes of the events. In another embodiment, the player's game ticket(s) might be printed and provided to the player, such as in the form of a printed receipt. For example, the game ticket might be printed via a printer of the gaming machine 22 or kiosk 28.

In one embodiment, each game ticket may be assigned a unique identifier, such as a unique code. The game ticket information (selected event(s) and assigned numbers) may be stored in association with the assigned code. That code may also be linked to the game ticket, such as printed on the ticket or displayed on the ticket, such as for redemption. For example, a winning ticket might be presented by a player to a casino cashier who scans the ticket code (such as from a physical ticket or a image of the ticket displayed on the user's device 30), whereby the system compares the ticket code to the ticket codes and tickets stored in the system to verify if the ticket was winning and, if so, the amount that should be awarded to the player.

When the events are played, information may be provided to the game server 24 regarding the results of the one or more events, or the game server 24 may transmit requests for results information, such as to an external system. The game server 24 may compare the results to the assigned numbers to determine whether the outcome of the game is winning or losing, as described in more detail below. If the outcome of the game is winning, the player may be paid winnings, such as by dispensing a monetary value ticket from the gaming machine 22 or kiosk 28, by the player presenting the ticket for redemption (paper or electronically), by transfer to a player's account or wallet, etc.

As described in more detail below, in one embodiment of the invention, the outcome of the game is determined by comparing the assigned game numbers to scores of the contests of the one or more sporting events. When the assigned game numbers are single digit numbers and the actual scores are two or more digit numbers, the comparison is preferably to the final digit of the score.

It will be appreciated that one aspect of the invention is the generation and display of graphical elements, such as icons, which the player may select from. The selected icons are graphically transformed into assigned numbers. The assigned numbers may be referred to as player or game numbers, as they are used in determining the outcome of the game. This display process is not only entertaining, but acts as a mechanism for the player's selection of game numbers in a manner that the player cannot control the particular numbers which are generated.

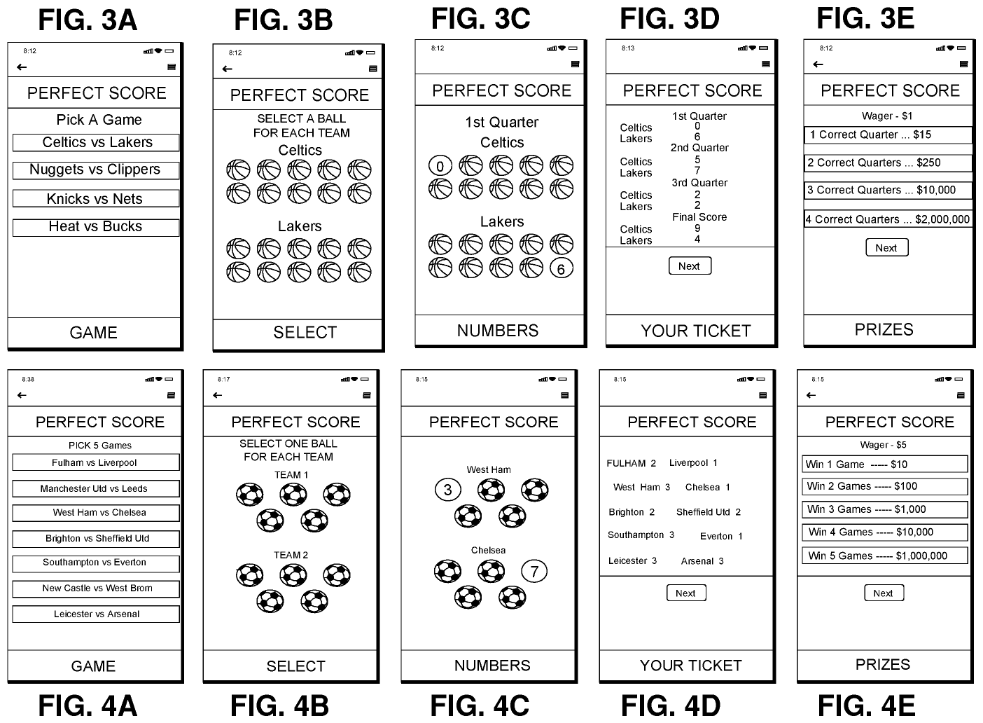

One example of the invention will be described with reference to FIGS. 3A-E. As illustrated in FIG. 3A, a player may select an event. In this example, the event comprises a basketball game between two teams, such as where the player may be given the opportunity to select a game from a plurality of upcoming games. The event information may be displayed in various manners, including information regarding the event, such as the name of the teams, the date/time of the event(s), etc. In this example, the player has selected “Celtics vs. Lakers.”

As illustrated in FIG. 3B, a plurality of icons may be displayed relative to each of the opponents of the event, e.g. in this example, the Celtics and the Lakers. The icons may have various shapes and sizes and may be arranged in various manners. For example, as illustrated, the icons may be images of elements used in the same (basketballs relative to basketball games, soccer balls relative to soccer games, etc.). The number of icons may vary, but in a preferred embodiment, comprises ten (10) icons for each team.

As illustrated in FIG. 3C, the player selects one icon for each of the two opponents. As also illustrated in FIG. 3C, a number is assigned to each selected icon. In one embodiment, numbers are randomly assigned to the icons before the selection process, and when an icon is selected, the number assigned thereto is revealed. In another embodiment, once the player selects an icon or icons, numbers are randomly selected and assigned thereto. In either manner, the assigned numbers are preferably not revealed until after the player has selected the icons. In this case, the assigned numbers are 0 for “Celtics” and 6 for “Lakers.”

This process is repeated, pursuant to steps S2A-2C above, for each contest of the event, which in this case comprises quarters of the basketball game.

FIG. 3D illustrates a completed game ticket after such selections where, as illustrated, based upon the player's selection of icons, different numbers have been assigned to the Celtics and Lakers for each quarter of the game.

The outcome of the game is then determined with reference to the selected event—in this case the game between the Celtics and the Lakers. In one embodiment, the player attempts to match the last digit of the score of each team at a designated time to the numbers corresponding to the selected icons at the designated times. For example, relative to the game ticket illustrated in FIG. 3D, in order to obtain a winning outcome as to the first contest—which comprises the score at the end of the first quarter, the score of the game at the end of the first quarter would have to end in a 0 for the Celtics and a 6 for the Lakers (e.g. Celtics 30-Lakers 26).

As illustrated in FIG. 3E, winnings may be awarded for a winning outcome. In one embodiment, the winnings may depend upon a number of contests of the game that the player has won, such as whether the assigned numbers for each contest (quarter) matched the scores of the game at one, two, three or all four quarters. As illustrated, the winnings may be higher for more contest wins, and may be very high (lottery-type) for winning all of the contests. In this case, the player might be awarded first winnings if they won any 1 of the contests (e.g. the assigned numbers matched the final digits of the scores at the end of any of the 4 quarters of the game), second (and higher) winnings if they won any 2 of the contests, third (and yet higher) winnings if they any 3 of the contests, and fourth (and highest, such as a jackpot) winnings if they won all 4 of the contents. Of course, other winning combinations might be designated. For example, the game could be played so that the player only wins if they win all of the contests.

As indicated, in a preferred embodiment of the game of the invention, the game is played as a wagering game. Thus, the player may be required to place a wager to play the game. The amount of the wager may vary. In the example illustrated in FIGS. 3A-E, the wager is $1. The amount of winnings may be tied to the amount wagered.

FIGS. 4A-E illustrate another example where the game is presented relative to at least four (4), and in this case five (5) events, where each event comprises an event between different opponents. In this example, the player may select five (5) events, such as five (5) upcoming soccer matches from a set of matches. In this case, each contest of the wagering game then comprises one of the different events (rather than, as in the example described relative to FIGS. 3A-E, different portions of one event between the same two opponents).

Once again, a plurality of icons are displayed for each team, and the player picks an icon relative to each team, as which point a number is displayed corresponding to each selected icon. In this case, the numbers may comprise 0, 1, 2, 3 and 4+, representing the final score of a team in the soccer match as 0, 1, 2, 3 and 4 or more. This process is repeated relative to each game (and the teams thereof) selected by the better.

FIG. 4D illustrates an example of a completed game ticket showing the different games, associated teams and assigned numbers for each team. As illustrated in FIG. 4E, the player may be declared to be a winner of the game if the final score of any of the soccer games (the “contests” of the wagering game) matches the assigned numbers, or for combinations of contest wins (any two of the soccer games, any three, etc.)

The principles of the invention may be applied to other variations of the game. For example, in one variation, a player might select more than one set of icons for one or more contests, thus providing the player with more than one opportunity to win a contest. In such a configuration, a player may be assigned more than one set of game numbers for one or more contents of the game.

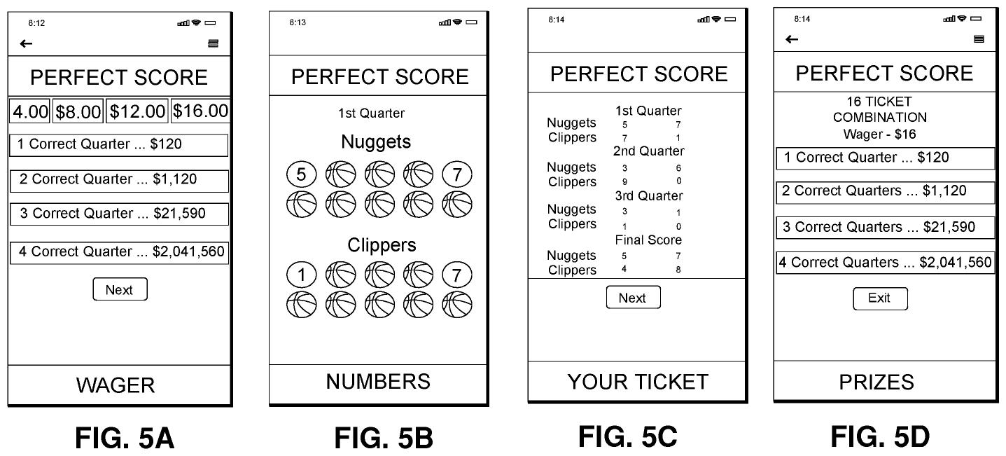

For example, FIGS. 5A-D illustrate a configuration in which a player has elected to play two sets of game numbers. As a result, the player selects two sets of icons for each contest—in this case quarters of a basketball game between the Denver Nuggets and the Los Angeles Clippers, and where game numbers have been assigned/revealed relative to those icons. In this example, the first set of game numbers for the first contest (quarter) is 5 (Nuggets)-7 (Clippers) and the second set of game numbers is 7 (Nuggets)-1 (Clippers). Thus, if the player is awarded winnings for any contest win, the player would win if the score at the end of the first quarter of the game between the Nuggets and the Clippers ended in 5 (Nuggets)-7 (Clippers) OR 7 (Nuggets)-1 (Clippers).

In such a configuration, the player may be required to place a larger wager as tied to the number of “entries”—where each entry is the selection of icons (and associated assigned numbers) relative to a contest which, if won, yields a winning outcome. Of course, in some embodiments, a player might select and play three or more sets of game numbers for the contents of the game. In the embodiment described above, the game is presented relative to at least four (4) contests, such that the odds of winning all four (4) contests is very low, and preferably sufficiently low that a very large award can be awarded (paid from wagers) for such a winning outcome. In one preferred embodiment, the game is configured to provide at least one jackpot award of at least $1,000,000, and where the odds of winning that jackpot is 1 in 1,000,000 or lower (such as 1 in 2,000,000, etc.).

In a preferred embodiment, icons are selected for each contests and game numbers are independently assigned to each contest. However, it would be possible to play the game with one set of assigned game numbers which is used in all of the contests.

In the embodiments described above, each game is treated independently of all of the others. In particular, numbers may be randomly selected and assigned to icons for each player's game, independent of one another. In this configuration, it is possible for two players to select icons which result in the same randomly assigned numbers for one or more contests of the game, such that both players might win their games for the same outcome(s) of the sporting event(s). In the case of a four contest game where both players win all four contests, this would result in both players being awarded the “jackpot” win. In the case of a casino offering the game, this would be undesirable.

As such, in a second embodiment of the invention, each of the possible number combinations for a predetermined number of events is pre-generated and the selection of the icons represents the random assignment of one of the permutations for the totality of outcomes. For example, in a scenario where there a 10 numbers available per icon resulting in a 1 in 100 chance to win each contest, and where the game comprises 4 contests, there would be 100,000,000 unique combinations or “entries.” This would provide 100,000,000 possible entries and each entry would be distributed randomly to each participant. This selection model would be beneficial for promotional games or real money games where a winning entry is guaranteed to exist, there needs to be a finite number of entries, and/or to ensure that there is only one winner.

In one configuration, the game server 24 may be configured to generate the entries. The entries may be stored in a database, such as where each entry is assigned a code or number. In the case of an electronic implementation of the game, the game server 24 may assign entries, such as based upon wagers placed by players and the players' selection of icons. Of course in some embodiments, the entries might be associated with printed game cards.

The selection process can be a real or virtual selection of a pre-populated game ticket, or the process can use the icons to select a location in a virtual container to obtain an entry and the numbers corresponding to the icons would be revealed by the selected icons. An application for this method would be a promotion where 100,000,000 entries are created for a major event or combination of events and each entry is awarded to a participant with a fixed prize schedule based on winning one, two, three, and all four events. Another application is where players purchase a ticket with a finite number of entries where there is a guaranteed winner and a guaranteed jackpot prize.

The present invention has a number of advantages and solves a number of problems.

First, the invention solves offers a simpler way to assign numbers to sports event outcomes, where icons are displayed for each team/opponent and the player makes selections of those displayed icons. This graphical representation (and transformation from a selected icon to a number) both enables a player's input of a selection and an assignment of a corresponding number, and does so in a single easy to use and entertaining interface.

The invention allows for the award of a jackpot type payout by combining multiple contests as part of one wager. For most sporting events, the contests would be the final outcome of multiple sporting events or in the case of a sport that has quickly changing scores like basketball, portions of a single event.

In one embodiment, a game of the invention has multiple contents, preferably 4 or more. The structure for winning revolves around having at least one winning outcome and increased payouts for 2 winning outcomes, 3 winning outcomes, etc.

As indicated herein, the invention solves various problems with existing systems and methods for determining winning outcomes associated with one or more sports events. The invention comprises a technological/technical solution to those problems. In particular, an aspect of the invention is a unique system which is configured to generate graphical selectable information relating to one or more contents, to transform aspects of graphical elements to numbers, to generate entries or tickets, and to verify game outcomes by comparing the entries or tickets to information regarding real world sporting events.

A particular aspect of the invention is the structure of generating game numbers for a plurality of contests as part of the same game, whereby the odds of achieving certain winning outcomes is sufficiently low that very high winning payouts may be offered (from the pool of funds which is generated from wagers placed, while still retaining a profit).

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming system configured to present at least one lottery type game based upon at least one sporting event, comprising:
a user device, said user device comprising a controller, a display, at least one user input, and a communication interface;
a database; and
a game server, said game server comprising a processor, a memory, a communication interface, and machine-readable code stored in said memory and executable by said processor to cause said game server to:
relative to a plurality of contests relating to the at least one sporting event:
(a) cause said display of said user device to display a first set of icons corresponding to a first opponent and a second set of icons corresponding to a second opponent;
(b) receive, from said user device, input regarding a selection of one of the icons from the first set of icons and one of the icons from the second set of icons;
(c) assign numerical values to the selected icons;
(d) cause said display of said user device to graphically transform the selected icons to the assigned numerical values; and
(e) repeat steps (a)-(d) for each of the plurality of contests;
store, in said database, information regarding said numerical values assigned to said plurality of contests; and
determine the outcome of said lottery type game by comparing a score which corresponds to each contest of the at least one sporting event to the stored assigned numerical values for the corresponding contest to determine one or more matches thereof.

2. The gaming system in accordance with claim 1, wherein said user devices comprises at least one of a gaming machine, a kiosk and a computing device.

3. The gaming system in accordance with claim 1, wherein said at least one sporting event comprises a plurality of sporting events, each contest comprises one of said sporting events, the first and second opponents of each of said sporting events are different.

4. The gaming system in accordance with claim 3, wherein said sporting events comprise different soccer games.

5. The gaming system in accordance with claim 3, wherein said first set of icons comprises 5 icons and said second set of icons comprises 5 icons.

6. The gaming system in accordance with claim 5, wherein said icons have the appearance of a soccer ball.

7. The gaming system in accordance with claim 4, wherein said assigned numerical values are each selected from the group consisting of: “0”, “1”, “2”, “3” and “4 or more”.

8. The gaming system in accordance with claim 1, wherein said plurality of contests comprise different portions of the same sporting event.

9. The gaming system in accordance with claim 8, wherein said different portions comprises quarters of said sporting event.

10. The gaming system in accordance with claim 1, wherein said first set of icons comprise 10 icons and said second set of icons comprise 10 icons.

11. The gaming system in accordance with claim 10, wherein said assigned numerical values are selected from the set of the numbers 0 through 9.

12. The gaming system in accordance with claim 11, wherein said assigned numerical values are randomly selected from the set.

13. The gaming system in accordance with claim 1, wherein an outcome of said lottery type game is winning when a score which corresponds to at least one of the contests of the at least one sporting event matches the assigned numerical values for the corresponding contest.

14. The gaming system in accordance with claim 13, wherein said score matches the assigned numerical values when a final digit of said score of said first opponent for the contest matches the corresponding assigned numerical value for the first opponent for that contest and a final digit of said score of said second opponent for the contest matches the corresponding assigned numerical value for the second opponent for that contest.

15. The gaming system in accordance with claim 1, wherein said game server is configured to receive, from said user device, a selection of said at least one sports event.

16. The gaming system in accordance with claim 1, wherein said assigned numerical values are selected from a pre-generated entry selected from a set of entries comprising all possible permutations of outcomes.

17. The gaming system in accordance with claim 1, wherein said game server is further configured to generate a game ticket, said game ticket having said assigned numerical values for each of said contests associated therewith, wherein information regarding said game ticket is stored in said database.

18. The gaming system in accordance with claim 1, wherein game server causes said display of said user device to display a graphical representation of said game ticket.

19. The gaming system in accordance with claim 1, wherein said game server is further configured to award an award for a winning outcome of said game.

20. The gaming system in accordance with claim 19, wherein at least one award comprise a jackpot.
